(19) United States
(12) Patent Application Publication
(10) Pub. No.: US 2011/0250460 A1
(43) Pub. Date: Oct. 13, 2011

(54) TRANSPARENT ADHESIVE SHEET FOR FLAT PANEL DISPLAY, AND FLAT PANEL DISPLAY

(75) Inventors: Tomohide Banba, Osaka (JP); Tatsuya Suzuki, Osaka (JP); Hiroaki Fumoto, Osaka (JP); Yasushi Buzoujima, Osaka (JP)

(73) Assignee: NITTO DENKO CORPORATION, Ibaraki-shi (JP)

(21) Appl. No.: 13/124,618

(22) PCT Filed: Oct. 16, 2009
(86) PCT No.: PCT/JP2009/067924

§ 371 Date: Jun. 22, 2011

(30) Foreign Application Priority Data
Oct. 17, 2008 (JP) 2008-268878

(51) Int. Cl. B32B 7/12; C09J 183/05; B32B 17/10

(52) U.S. Cl. 428/429; 525/474

(57) ABSTRACT

The invention provides a transparent adhesive sheet for a flat panel display, which does not permit delamination on the adhesion surface to the glass plate even if a stress such as distortion, bending and the like is applied to the display, and does not produce bubbles in the boundary with the glass plate. The transparent adhesive sheet for a flat panel display comprised of a cured product of a composition comprising (A) a polyoxyalkylene based polymer having at least one alkenyl group in one molecule, (B) a compound having an average of not less than 2 hydrosilyl groups in one molecule, and (C) a hydrosilylation catalyst.

### TECHNICAL FIELD

The present invention relates to a transparent adhesive sheet for a flat panel display having superior adhesion stability. The present invention particularly relates to a transparent adhesive sheet for a flat panel display having superior adhesion stability to a glass plate.

### BACKGROUND ART

Conventionally, in a flat panel display such as a liquid crystal display and the like, the display panel and a protective panel containing a transparent plate such as acrylic plate, glass plate and the like, which protects the display panel, are set with a given gap so that, when an impact of some kind is applied to the flat panel display, the impact will not be transmitted to the display panel.

However, since the gap is generally a layer of air, light reflection loss is high due to the difference in the refractive index between the layer of air and the material constituting the above-mentioned display panel and protective panel, thus problematically failing to afford good visibility.

Thus, for example, to remove the gap (air layer) between a liquid crystal panel and a protection panel in a liquid crystal display, a liquid crystal display wherein an adhesive (silicone adhesive) made of a polyorganosiloxane composition having a particular degree of plasticity is filled in between a liquid crystal panel and a protective panel has been proposed (patent document 1). For a similar object, a technique for integrating a liquid crystal panel and a transparent plate by adhesion is known, which includes adhering a transparent plate for protection to a liquid crystal panel via a transparent adhesive sheet comprising acrylic adhesive (e.g., sheet obtained by processing acrylic acid ester copolymer crosslinked by epoxy, isocyanate, melamine or metal compound crosslinking agent, UV curing acrylic adhesive and the like) (patent reference 2 etc.).

When a protective transparent plate is adhered to a liquid crystal panel of a liquid crystal display via a transparent adhesive sheet, the display panel and the protective transparent plate need to be adhered without a position gap. However, adhesion mistakes cannot be completely eliminated and, when an adhesion mistake occurs, since the aforementioned silicone and acrylic transparent adhesive sheets are difficult to detach once adhered to a transparent plate or a liquid crystal panel, the display panel needs to be disposed. Such disposal of display panels has been a serious problem since liquid crystal displays with comparatively large area, which are mounted on television, PC monitor and the like, have a large area of liquid crystal panel and are expensive. Therefore, the Applicant of the present application previously proposed a transparent adhesive sheet having a polyoxyalkylene polymer as a main component as a transparent adhesive sheet which shows easy-to-release property immediately after adhesion to a liquid crystal panel or a protective transparent plate, and thereafter shows a high release force by heating (i.e., can be adhered with a high adhesion force), so that adhesion can be redone when the above-mentioned adhesion mistakes occurs (Japanese Patent Application No. 2007-112194).

### DOCUMENT LIST

### Patent Documents

patent document 1: JP-A-2004-212521
patent document 2: JP-A-2002-348546

### SUMMARY OF THE INVENTION

### Problems to be Solved by the Invention

With the recent pervasiveness of mobile phones, portable game devices, car navigation systems and the like, a demand for a compact liquid crystal display to be used therefor has rapidly increased. Such compact liquid crystal display has been downsized as well as one layer therein has become thinner, and therefore, the display is easily subjected to a stress such as distortion and bending. Thus, when a liquid crystal display is assembled by adhering a protective transparent plate made of a glass plate and a liquid crystal panel via the adhesive sheet proposed above, which comprises a polyoxyalkylene polymer as a main component, for example, new problems such as partial detachment between a protective transparent plate made of a glass plate and a transparent adhesive sheet and development of bubbles, which occur when a stress such as distortion and bending is applied to a display after assembly, have been developed.

The present invention has been made in view of the above-mentioned situation, and the problem to be solved by the invention is to provide a transparent adhesive sheet for a flat panel display, which does not permit a delamination on the adhesion surface to the glass plate and does not produce bubbles in the boundary with the glass plate, even if a stress such as distortion, bending and the like is applied to the display.

### Means of Solving the Problems

The present inventors have conducted intensive studies in an attempt to solve the aforementioned problems and found that, for prevention of a delamination on the adhesion surface to the glass plate of a display assembled by adhering the display panel and the protective transparent plate via the adhesive sheet, even if a stress such as distortion, bending and the like is applied to the display, the adhesion force between the transparent adhesive sheet and the glass plate in 180° peel adhesion force needs to be at least not less than 10N/25 mm and, moreover, a delamination (development of bubbles) in the boundary of the transparent adhesive sheet and the glass plate due to the influence of a stress loaded on the display during mounting of a display after assembly on a portable image display equipment (mobile phones, portable game devices, Personal Digital Assistant (PDA) etc.) and packaging and transport of the display cannot be sufficiently suppressed unless such adhesion force is not reached in a short time from the start of assembly of a display (adhesion of an adhesive sheet to a glass plate). Based on such finding, they have conducted further studies and found that an adhesive sheet obtained by curing a composition comprising a polyoxyalkylene polymer having at least one alkenyl group in one molecule (Component A) and a compound having two or more hydrosilyl groups on average in one molecule (Component B), wherein the total number of moles of the hydrosilyl group in Component B is higher than the total number of moles of the alkenyl group in Component A and Component A and Component B are contained at an amount ratio such that the number of moles of excess hydrosilyl group in Component B (total number of moles of hydrosilyl group in Component B—total number of moles of alkenyl group in Component A) is not less than 50% of the total number of moles of the alkenyl group in Component A, shows easy-to-release property immediately after adhesion to a glass plate but thereafter shows quickly increased adhesion force to a glass plate by standing at room temperature even without heating thereafter, and shows a 180° peel adhesion force that reaches the above-mentioned 10N/25 mm in 150 hr at the latest from the adhesion to the glass plate, which resulted in the completion of the present invention.

Accordingly, the present invention provides the following.

(1) A transparent adhesive sheet for a flat panel display comprised of a cured product of a composition comprising the following components A-C, wherein the total number of moles of the hydrosilyl group in Component B is higher than the total number of moles of the alkenyl group in Component A, and Component A and Component B are contained at an amount ratio such that the number of moles of excess hydrosilyl group in Component B (total number of moles of hydrosilyl group in Component B−total number of moles of alkenyl group in Component A) is not less than 50% of the total number of moles of the alkenyl group in Component A:

A: a polyoxyalkylene based polymer having at least one alkenyl group in one molecule

B: a compound having an average of not less than 2 hydrosilyl groups in one molecule, and

C: a hydrosilylation catalyst.

(2) The transparent adhesive sheet of the above-mentioned (1), wherein the number of moles of excess hydrosilyl group in Component B (total number of moles of hydrosilyl group in Component B−total number of moles of alkenyl group in Component A) is not less than 80% of the total number of moles of the alkenyl group in Component A.
(3) The transparent adhesive sheet of the above-mentioned (1), wherein the number of moles of excess hydrosilyl group in Component B (total number of moles of hydrosilyl group in Component B−total number of moles of alkenyl group in Component A) is not less than 100% of the total number of moles of the alkenyl group in Component A.
(4) The transparent adhesive sheet of any of the above-mentioned (1)-(3), which is used for adhesion of adjacent two layers in a multi-layer structure on the display surface side in a flat panel display, which structure comprising a display panel and a protective transparent plate, or a display panel and the protective transparent plate and further at least one other functional layer between them.
(5) The transparent adhesive sheet of the above-mentioned (4), wherein at least one of the adjacent two layers is a glass plate.
(6) A flat panel display comprising a protective transparent plate comprised of a glass plate and a display panel, which are integrated by adhesion via the transparent adhesive sheet of any of the above-mentioned (1)-(3) disposed between the protective transparent plate and the display panel.
(7) A flat panel display comprising a protective transparent plate comprised of a glass plate, a display panel and a touch panel inserted between the protective transparent plate and the display panel, wherein the transparent adhesive sheet of any of the above-mentioned (1)-(3) is disposed between a glass plate on the outermost layer of the touch panel and the protective transparent plate, and between a glass plate on the outermost layer of the other side of the touch panel and the display panel, whereby the protective transparent plate, the display panel and the touch panel are integrated by adhesion.

### Effect of the Invention

The transparent adhesive sheet of the present invention is superior in flexibility and shows a 180° peel adhesion force of not less than 10N/25 mm by standing at room temperature after adhesion, preferably not less than 10N/25 mm generally within 150 hr by standing at room temperature, to various material surfaces (particularly glass surface), even when heating is not performed (at room temperature). Thus, for example, when a display is assembled by adhering a display panel and a protective transparent plate via the adhesive sheet, even if a stress such as distortion, bending and the like is applied thereafter to the display during mounting of a display after assembly on a portable image display equipment (mobile phones, portable game devices, Personal Digital Assistant (PDA) etc.) and packaging and transport of the display, since the adhesive sheet can be adhered with a high adhesion force to a display panel and a protective glass plate, a good adhesion state free of delamination can be maintained and a display stably maintaining superior visibility can be realized.

In addition, the transparent adhesive sheet of the present invention not only shows a high adhesion force (high release force) to various material surfaces (particularly glass surface) but also does not corrode transparent conductive materials on contact therewith. Therefore, even when a flat panel display with a touch panel comprising a touch panel between a display panel and a protective transparent plate is constituted, the transparent adhesive sheet of the present invention adheres with a high adhesion force to a glass plate placed on the outermost layer of the touch panel (i.e., a glass plate having a transparent electrode layer) without leaving a clearance, by placing the transparent adhesive sheet between the glass plate on the outermost layer of a touch panel and the protective transparent plate, and between the glass plate on the outermost layer of a touch panel and the display panel. Therefore, a flat panel display stably maintaining superior visibility can be obtained, which maintains superior adhesion state free of delamination not only to a display panel and a protective glass plate but also to a glass plate on the outermost layer of a touch panel, even if a stress such as distortion, bending and the like is applied to the display.

### BRIEF DESCRIPTION OF THE DRAWINGS

FIG. 1 is a schematic sectional view of a liquid crystal display wherein a protective transparent plate is integrated with a liquid crystal panel by adhesion via the transparent adhesive sheet of the present invention.

FIG. 2 is a schematic sectional view of a liquid crystal display wherein a touch panel and a protective transparent plate are integrated with a liquid crystal panel by adhesion via the transparent adhesive sheet of the present invention.

FIG. 3 shows time course changes of release force of the adhesive sheet from glass.

### DESCRIPTION OF EMBODIMENTS

The present invention is explained in the following by referring to a preferable embodiment.

The “flat panel display” in the present invention is a concept including a liquid crystal display (LCD), a plasma display panel (PDP), an organic or inorganic electroluminescent display (ELD), a surface electrolysis display (SED) and the like.

In addition, the “display panel” means a panel component containing a display material in, for example, various flat-panel displays such as a panel component containing a liquid crystal material in a liquid crystal display (LCD) (hereinafter also to be referred to as a “liquid crystal panel”) and the like, and a “display module” is the panel member mounted with a driver IC and the like for driving.

The transparent adhesive sheet of the present invention for a flat panel display is characteristically comprised of a cured product of a composition comprising the following components A-C, wherein the total number of moles of the hydrosilyl group in Component B is higher than the total number of moles of the alkenyl group in Component A, and Component A and Component B are contained at an amount ratio such that the number of moles of excess hydrosilyl group in Component B (total number of moles of hydrosilyl group in Component B−total number of moles of alkenyl group in Component A) is not less than 50% of the total number of moles of the alkenyl group in Component A.

A: a polyoxyalkylene based polymer having at least one alkenyl group in one molecule

B: a compound comprising an average of not less than 2 hydrosilyl groups in one molecule and

C: a hydrosilylation catalyst.

Since the transparent adhesive sheet of the present invention shows a high adhesion force (180° peel adhesion force of not less than 10N/25 mm, preferably not less than 11N/25 mm) to various material surfaces (particularly glass surface) by standing at room temperature after adhesion. Thus, when it is used for adhesion of adjacent two layers in a multi-layer structure on the display surface side in a flat panel display, which structure comprising a display panel and a protective transparent plate, or a display panel and the protective transparent plate and further at least one other functional layer between them, the adjacent two layers in the multi-layer structure on the display surface side are strongly integrated by adhesion free of clearance. Moreover, the 180° peel adhesion force becomes not less than 10N/25 mm by 150 hr from the adhesion at the latest. Therefore, even if a stress such as distortion, bending and the like is applied to the display during operations of mounting a display after assembly on mobile phones, portable game devices, Personal Digital Assistant (PDA) etc. and a process of mounting, display packaging and transporting, since the adhesive sheet can be adhered with a high adhesion force to a display panel, a protective transparent plate and other functional layers, even if a stress such as distortion, bending and the like is applied to the display, a flat panel display without partial detachment (without development of bubbles and the like) of transparent adhesive sheet, which is superior in visibility and mechanical durability can be realized.

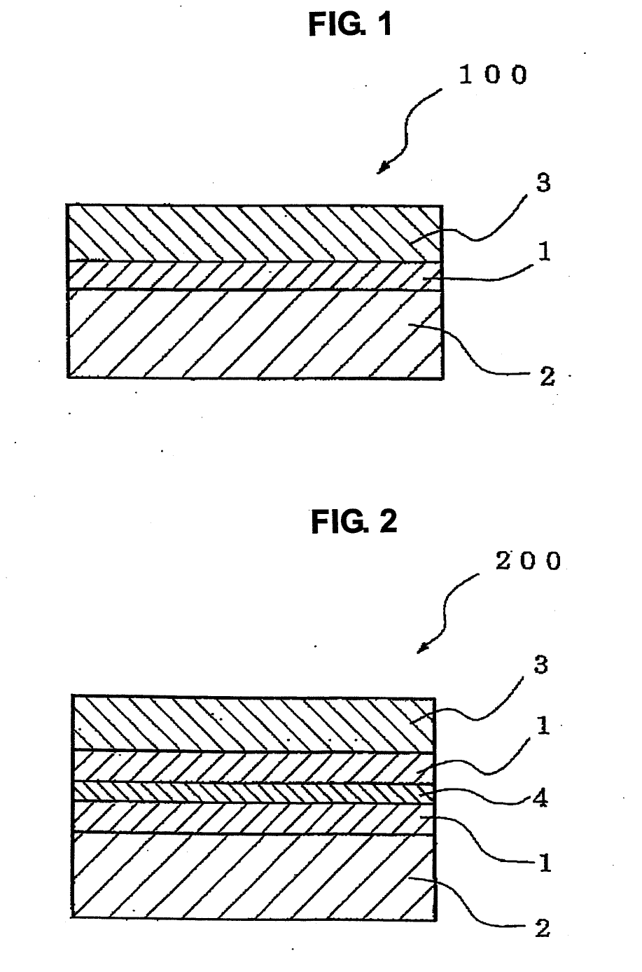

FIG. 1 is a schematic sectional view of a liquid crystal display wherein a protective transparent plate comprised of a glass plate is integrated with a liquid crystal display panel by adhesion via the transparent adhesive sheet of the present invention. In the liquid crystal display 100, a transparent adhesive sheet 1 of the present invention is placed between a liquid crystal display panel 2 and a protective transparent plate 3 comprised of a glass plate, the transparent adhesive sheet 1 is adhered to the liquid crystal display panel 2 and the protective transparent plate 3 comprised of a glass plate, whereby the liquid crystal panel 2 and the protective transparent plate 3 are integrated by adhesion. As a io protective transparent plate of a display panel of a flat panel display, transparent resin plates such as acrylic plate, polycarbonate plate and the like can be used besides glass plates. Glass plates are preferable in terms of transparency, abrasion resistance, size stability against temperature change and the like, and therefore, a glass plate is often used when a high grade flat panel display is to be constituted. The transparent adhesive sheet of the present invention particularly adheres with a high adhesion force to a glass plate. Therefore, the liquid crystal display 100 realizes a high grade flat panel display that does not develop bubbles (air gap) in the interface between a protective transparent plate 3 made of a glass plate and a transparent adhesive sheet 1 even if a stress such as distortion, bending and the like is applied.

In flat-panel displays represented by liquid crystal displays, an impact mitigation film (e.g., polyethylene terephthalate film, polyethylene naphtha late film, polycarbonate film, polypropylene film, polyethylene film etc.) which mitigates impact when a protective transparent plate is subjected to impact from the outside, or a shatterproof film (e.g., polyethylene terephthalate film, polyethylene naphtha late film, polycarbonate film, polypropylene film, polyethylene film etc.) for preventing a protective transparent plate from shattering when it is broken may be inserted. To improve view angle and contrast ratio of display screens, an optical compensation film (e.g., polycarbonate film, cycloserine resin film, acrylic resin film etc., these resin films and those other than these resin films, to which a liquid crystal material is applied and oriented on the surface, etc.) or a glass plate (film) may be inserted. Furthermore, an attached mechanism such as a touch panel (panel component consisting of a glass plate having a transparent electrode (detection electrode layer)/an adhesive layer/a glass plate having a transparent electrode (driving electrode layer)) and the like may be inserted between a display panel and a protective transparent plate. Thus, when a front multi-layer structure part wherein one or more function layers other than the protective transparent plate are provided between the display panel and the protective transparent plate is formed, the transparent adhesive sheet of the present invention can be used for adhesion of two adjacent layers in such multi-layer structure part on the visual surface side, since it can be adhered with a high adhesion force to various materials in a short time after adhesion.

FIG. 2 is a schematic sectional view of a liquid crystal display wherein the transparent adhesive sheet of the present invention is used to adhere layers in the above-mentioned multi-layer structure part on the visual surface. In the liquid crystal display 200, a touch panel [laminate of a glass plate having a transparent electrode (detection electrode layer)/an adhesion layer/a glass plate having a transparent electrode (driving electrode layer)] 4 is provided between a liquid crystal display panel 2 and a protective transparent plate 3 comprised of a glass plate. The transparent adhesive sheet 1 of the present invention is inserted between the liquid crystal display panel 2 and the touch panel 4, and between the touch panel 4 and the protective transparent plate 3, whereby the touch panel 4 and the protective transparent plate 3 are integrated with the liquid crystal display panel 2 by adhesion. The transparent adhesive sheet 1 of the present invention can also be used for an adhesion layer to adhere a glass plate having two sheets of transparent electrodes in the touch panel 4.

As shown, a touch panel is inserted between a display panel and a protective transparent plate comprised of a glass plate, and the transparent adhesive sheet of the present invention is placed between the glass plate on the one outermost layer of the touch panel and the protective transparent plate, and between the glass plate on the other outermost layer of the touch panel and the display panel. In the liquid crystal display 200, bubbles (air gap) due to partial detachment are not developed between layers in a multi-layer structure, even if a stress such as distortion, bending and the like is applied to the display. Therefore, a flat panel display with a touch panel, which is free of inconveniences such as decreased visibility of displayed images and the like even when an external stress is applied, and has superior mechanical durability, is realized.

In the transparent adhesive sheet of the present invention, the “polyoxyalkylene polymer having at least one alkenyl group in one molecule” of Component A is not subject to limitation, and various types can be used. In particular, one wherein the main chain of the polymer has a repeat unit represented by the formula (1) shown below is suitable.

—R¹—O— Formula (1)

wherein R¹ is an alkylene group.

R¹ is preferably a linear or branched alkylene group having 1 to 14, more preferably 2 to 4, carbon atoms.

As specific examples of the repeating unit represented by the formula (1), —CH₂O—, —CH₂CH₂O—, —CH₂CH(CH₃)O—, —CH₂CH(C₂H₅)O—, —CH₂C(CH₃)₂O—, —CH₂CH₂CH₂CH₂O— and the like can be mentioned. The main chain skeleton of the polyoxyalkylene based polymer may consist of only one kind of repeating unit, and may consist of two kinds or more of repeating units. Particularly, with regard to availability and workability, a polymer with —CH₂CH(CH₃)O— as the main repeating unit is preferable. In the main chain of the polymer, a repeating unit other than the oxyalkylene group may be contained. In this case, the total sum of oxyalkylene units in the polymer is preferably not less than 80% by weight, particularly preferably not less than 90% by weight.

Although the polymer may be a linear polymer or a branched polymer, or a mixture thereof, it is preferable, for obtaining good adhesiveness, that the Component A polymer contain a linear polymer at not less than 50% by weight.

The molecular weight of the Component A polymer is preferably 500 to 50,000, more preferably 5,000 to 30,000, in terms of number-average molecular weight. If the number-average molecular weight is less than 500, the curing product obtained tends to be too brittle; conversely, if the number-average molecular weight exceeds 50,000, the curing product obtained tends to be so viscous that the workability is considerably reduced; therefore, these cases are undesirable. As mentioned herein, number-average molecular weight refers to a value obtained by the gel permeation chromatography (GPC) method.

The Component A polymer preferably has a narrow molecular weight distribution wherein the ratio of weight-average molecular weight and number-average molecular weight (Mw/Mn) is not more than 1.6; a polymer having an Mw/Mn of not more than 1.6 produces a decreased viscosity of the composition and offers improved workability. Hence, the Mw/Mn is more preferably not more than 1.5, still more preferably not more than 1.4. As mentioned herein, Mw/Mn refers to a value obtained by the gel permeation chromatography (GPC) method.

Here, measurements of molecular weight by the GPC method were performed using a GPC apparatus manufactured by Tosoh Corporation (HLC-8120GPC), and weight-average molecular weights were calculated on a polystyrene basis. The measuring conditions are as follows:

Sample concentration: 0.2% by weight (THF solution)

Sample injection volume: 10 μl

Eluent: THF

Flow rate: 0.6 ml/min

Measuring temperature: 40° C.

Column: sample column TSKgel GMH-H(S)

Detector: differential refractometer

With regard to the Component A polymer (polyoxyalkylene polymer having at least one alkenyl group in one molecule), the alkenyl group is not subject to limitation, but an alkenyl group represented by the formula (2) shown below is suitable.

H₂C═C(R²)— General Formula (2)

(wherein R² is a hydrogen atom or a methyl group)

The mode of binding of the alkenyl group to the polyoxyalkylene polymer is not subject to limitation; for example, alkenyl group direct bond, ether bond, ester bond, carbonate bond, urethane bond, urea bond and the like can be mentioned.

As specific examples of the Component A polymer, a polymer represented by the formula (3):

{H₂C═C(R^{3a})—R^{4a}—O}a₁R^{5a}

(wherein R^{3a} is a hydrogen atom or a methyl group; R^{4a} is a divalent hydrocarbon group having 1 to 20 carbon atoms, optionally having one or more ether groups, R^{5a} is a polyoxyalkylene polymer residue; a₁ is a positive integer.) can be mentioned. As R^{4a} in the formula, specifically, —CH₂—, —CH₂CH₂—, —CH₂CH₂CH₂—, —CH₂CH(CH₃)CH₂—, —CH₂CH₂CH₂CH₂—, —CH₂CH₂OCH₂CH₂—, or —CH₂CH₂OCH₂CH₂CH₂— and the like can be mentioned; for the ease of synthesis, —CH₂— is preferable.

A polymer having an ester bond, represented by the formula (4):

{H₂C═C(R^{3b})—R^{4b}—OCO}a₂R^{5b}

(wherein R^{3b}, R^{4b}, R^{5b} and a₂ have the same definitions as those of R^{3a}, R^{4a}, R^{5a}, and a₁, respectively)
can also be mentioned.

A polymer represented by the formula (5):

{H₂C═C(R^{3c})}a₃R^{5c}

(wherein R^{3c}, R^{5c} and a₃ have the same definitions as those of R^{3a}, R^{5a}, and a₁, respectively)
can also be mentioned.

Furthermore, a polymer having a carbonate bond, represented by the formula (6):

{H₂C═C(R^{3d})—R^{4d}—O(CO)O}a₄R^{5d}

(wherein, R^{3d}, R^{4d}, R^{5d} and a₄ have the same definitions as those of R^{3a}, R^{4a}, R^{5a} and a₁, respectively)
can also be mentioned.

It is preferable that at least 1, preferably 1 to 5, more preferably 1.5 to 3, alkenyl groups be present in one molecule of the Component A polymer. If the number of alkenyl groups contained in one molecule of the Component A polymer is less than 1, the curing is insufficient; if the number exceeds 5, the mesh structure becomes so dense that the polymer sometimes fails to exhibit a good adherence.

The Component A polymer can be synthesized according to the method described in JP-A-2003-292926, and any commercially available product can be used as is.

The “compound containing average two or more hydrosilyl groups in one molecule” of Component B is not particularly limited and may be any as long as it is a compound containing hydrosilyl groups (group having Si—H bond). From the viewpoint of easy availability of the starting materials and compatibility with Component A, organohydrogenpolysiloxane denatured by an organic component is particularly preferable. The polyorganohydrogen siloxane modified with an organic constituent more preferably has an average of 2 to 8 hydrosilyl groups in one molecule. Specific examples of the structure of polyorganohydrogensiloxane include those shown by

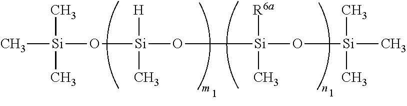

(wherein 2≦m₁+n₁≦50, 2≦m₁, and 0≦n₁. R^{6a} is a hydrocarbon group having 2 to 20 carbon atoms in the main chain thereof, optionally comprising one or more phenyl groups),

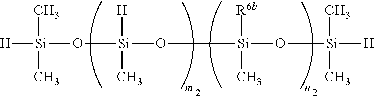

(wherein 0≦m₂+n₂≦50, 0≦m₂, and 0≦n₂. R^{6b} is a hydrocarbon group having 2 to 20 carbon atoms in the main chain thereof, optionally comprising one or more phenyl groups),
or,

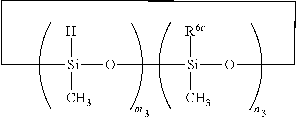

(wherein 3≦m₃+n₃≦20, 2≦m₃≦19, and 0≦n₃<18. R^{6c} is a hydrocarbon group having 2 to 20 carbon atoms in the main chain thereof, optionally having one or more phenyl groups) and the like, and ones having two or more of these units, represented by the following:

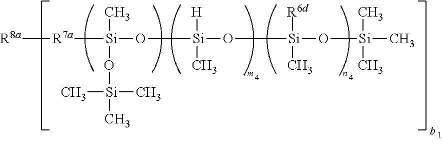

(wherein 1≦m₄+n₄≦50, 1≦m₄, and 0≦n₄. R^{6d} is a hydrocarbon group having 2 to 20 carbon atoms in the main chain thereof, optionally having one or more phenyl groups. 2≦b₁. R^{8a} is a divalent to tetravalent organic group, and R^{7a} is a divalent organic group, but R^{7a} may be absent depending on the structure of R^{8a}),

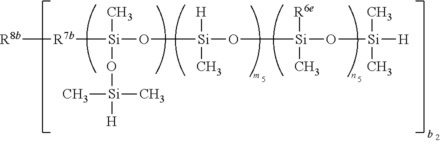

(wherein 0≦m₅+n₅≦50, 0≦m₅, and 0≦n₅. R^{6e} is a hydrocarbon group having 2 to 20 carbon atoms in the main chain thereof, optionally having one or more phenyl groups. 2≦b₂. R^{8b} is a divalent to tetravalent organic group, and R^{7b} is a divalent organic group. However, R^{7b} may be absent depending on the structure of R^{8b}), or

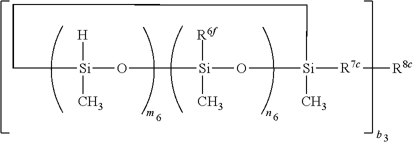

(wherein 3≦m₆+n₆≦50, 1≦m₆, and 0≦n₆. R^{6f} is a hydrocarbon group having 2 to 20 carbon atoms in the main chain thereof, optionally comprising one or more phenyl groups. 2≦b₃. R^{8c} is a divalent to tetravalent organic group, and R^{7c} is a divalent organic group. However, R^{7c} may be absent depending on the structure of R^{8c}) and the like.

The Component B preferably has good compatibility with the Component A and the component C, or good dispersion stability in the system. Particularly, if the viscosity of the entire system is low, use of an ingredient whose compatibility with any of the above-described ingredients is low as the Component B sometimes causes phase separation and a curing failure.

As a specific example of the Component B having relatively good compatibility with the Component A and the component C, or relatively good dispersion stability, the following can be mentioned.

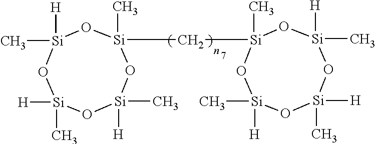

wherein n₇ is an integer of not less than 4 and not more than 10,

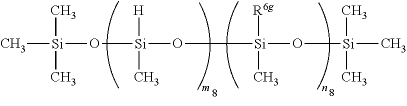

wherein 2≦m₈≦10 and 0≦n₈≦5, R^{6g} is a hydrocarbon group having eight or more carbon atoms.

As specific preferable examples of the Component B, polymethylhydrogen siloxane can be mentioned; for assuring compatibility with the Component A and adjusting the hydrosiltl group (Si—H group) content, a compound modified with α-olefin, styrene, α-methylstyrene, allylalkyl ether, allylalkyl ester, allylphenyl ether, allylphenyl ester or the like can be mentioned; as an example, the following structure can be mentioned.

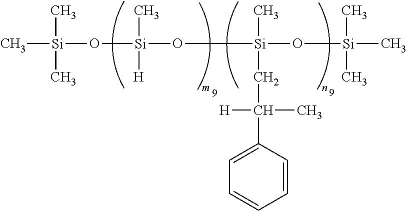

wherein 2≦m₉≦20, 1≦≦n₉20.

The Component B can be synthesized by a commonly known method, and any commercially available product can be used as is. As Component B, one kind of compound may be used alone, or two or more kinds of compounds may be used in combination.

In the present invention, the component C hydrosilylation catalyst is not subject to limitation; an optionally chosen one can be used. As specific examples, chloroplatinic acid; simple substance platinum; solid platinum carried by a carrier such as alumina, silica, or carbon black; a platinum-vinylsiloxane complex {for example, Ptₙ(ViMe₂SiOSiMe₂Vi)ₘ, Pt[(MeViSiO)₄]ₘ and the like}; a platinum-phosphine complex {for example, Pt(PPh₃)₄, Pt(PBu₃)₄ and the like}; a platinum-phosphite complex {for example, Pt[P(OPh)₃]₄, Pt[P(OBu)₃]₄ and the like}; Pt(acac)₂; the platinum-hydrocarbon conjugates described in U.S. Pat. Nos. 3,159,601 and 3,159,662 of Ashby et al.; the platinum alcoholate catalyst described in U.S. Pat. Nos. 3,220,972 of Lamoreaux et al. and the like can be mentioned. (In the formulas above, Me represents a methyl group, Bu represents a butyl group, Vi represents a vinyl group, Ph represents a phenyl group, acac represents an acetylacetonate, and each of n and m represents an integer.)

As examples of catalysts other than platinum compounds, RhC(PPh₃)₃, RhCl₃, Rh/Al₂O₃, RuCl₃, IrCl₃, FeCl₃, AlCl₃, PdCl₂.2H₂O, NiCl₂, TiCl₄ and the like can be mentioned.

These catalysts may be used alone, and may be used in combination of 2 or more kinds. With regard to catalyst activity, chloroplatinic acid, a platinum-phosphine complex, a platinum-vinylsiloxane complex, Pt(acac)₂ and the like are preferable.

Although the amount of the component C formulated is not subject to limitation, from the viewpoint of assurance of composition potlife and sheet transparency, the amount is generally not more than 1×10⁻¹ mol, preferably not more than 5.3×10⁻² mol, relative to 1 mol of alkenyl groups in the Component A; particularly, from the viewpoint of sheet transparency, the amount is more preferably not more than 3.5×10⁻² mol, particularly preferably not more than 1.4×10⁻³ mol. If the amount exceeds 1×10⁻¹ mol relative to 1 mol of alkenyl groups in the Component A, the finished impact absorption sheet is likely to undergo yellowing and the transparency of the sheet tends to be damaged. If the amount of the component C formulated is too low, the composition curing speed is slow, and the curing quality tends to be unstable; therefore, the amount is preferably not less than 8.9×10⁻⁵ mol, more preferably not less than 1.8×10⁻⁴ mol.

In the present invention, in the composition containing components A-C, it is important that the total number of moles of the hydrosilyl group in Component B is higher than the total number of moles of the alkenyl group in Component A, and Component A and Component B are contained at an amount ratio such that excess hydrosilyl group in Component B (total number of moles of hydrosilyl group in Component B−total number of moles of alkenyl group in Component A) is not less than 50% of the total number of moles of the alkenyl group in Component A. When an adhesive sheet obtained by curing a composition having such a particular composition is adhered to glass, excess hydrosilyl group in the sheet, which is derived from Component B, interacts with silanol group on the glass surface. As a result, the adhesion force increases with time without requiring a long time, and a high adhesion force (180° peel adhesion force is not less than 10N/25 mm) can be obtained.

In the present invention, in a composition containing components A-C, excess hydrosilyl group in Component B (total number of moles of hydrosilyl group in Component B−total number of moles of alkenyl group in Component A) is preferably not less than 80%, more preferably not less than 100%, of the total number of moles of the alkenyl group in Component A. While the upper limit thereof is not particularly limited, it is generally preferably not more than 1000%, more preferably not more than 500%, particularly preferably not more than 150%, of the total number of moles of the alkenyl group in Component A.

An adhesive sheet obtained by curing a composition, wherein the number of moles of excess hydrosilyl group in Component B (total number of moles of hydrosilyl group in Component B−total number of moles of alkenyl group in Component A) is less than 50% of the total number of moles of the alkenyl group in Component A, can afford a high adhesion force showing 180° peel adhesion force of not less than 10N/25 mm by a heat treatment in a high temperature environment of not less than 80° C. for generally not less than 24 hr. Such a heat treatment complicates an assembly step of a display, decreases the display producibility, and unpreferably causes deformation (development of dimensional changes, warpage) of plastic materials used for the display due to the heat.

Such composition containing the components A to C may contain a storage stability improving agent for the purpose of improving the storage stability. As this storage stability improving agent, a commonly known compound known as a storage stabilizer for the Component B of the present invention can be used without limitation. For example, a compound comprising an aliphatic unsaturated bond, an organic phosphorus compound, an organic sulfur compound, a nitrogen-containing compound, a tin compound, an organic peroxide and the like can be suitably used. Specifically, 2-benzothiazolyl sulfide, benzothiazole, thiazole, dimethylacetylene dicarboxylate, diethylacetylene dicarboxylate, 2,6-di-t-butyl-4-methylphenol, butylhydroxyanisole, vitamin E, 2-(4-morpholinyldithio)benzothiazole, 3-methyl-1-butene-3-ol, 2-methyl-3-butene-2-ol, organosiloxane containing an acetylenic unsaturated group, acetylene alcohol, 3-methyl-1-butyl-3-ol, diallyl fumarate, diallyl maleate, diethyl fumarate, dimethyl maleate, diethyl maleate, 2-pentenenitrile, 2,3-dichloropropene and the like can be mentioned, but these are not to be construed as limitative.

Where necessary, moreover, an adhesion-imparting agent may be added to improve adhesiveness to the liquid crystal panel and protective transparent plate. As examples of the adhesion provider, various silane coupling agents, epoxy resins and the like can be mentioned. In combination with a silane coupling agent and an epoxy resin, a catalyst for reacting silyl groups or epoxy groups can be added. When using them, their influence on the hydrosilylation reaction must be taken into consideration. Various filling agents, antioxidants, ultraviolet absorbents, pigments, surfactants, solvents, and silicon compounds may be added to the composition as appropriate. As specific examples of the above-described filling agents, silica micropowder, calcium carbonate, clay, talc, titanium oxide, zinc oxide, diatomaceous earth, barium sulfate and the like can be mentioned. Of these filling agents, silica micropowder, particularly micropowder silica having a particle diameter of about 50 to 70 nm (the BET specific surface area is 50 to 380 m²/g) is preferable; in particular, surface-treated hydrophobic silica is particularly preferable because of its high function to improve the strength in the preferred direction. Furthermore, a tackifier resin may be added to the composition as required to enhance the tack and other characteristics thereof; as examples of the tackifier resin, terpene resin, terpene phenol resin, petroleum resin, rosin ester and the like can be mentioned, one of which can be freely selected according to the intended use.

For the characteristic improvements, resins such as phenol resin, acrylic resin, styrene resin, and xylene resin can be added. An adhesive ingredient such as an acrylic adhesive, a styrene block adhesive, or an olefin adhesive can be added for the same purpose.

Moreover, the transparent adhesive sheet of the present invention has high transparency; for example, a sheet measured by the below-mentioned test method preferably shows a haze value of not more than 1.2%, more preferably not more than 0.9%. Therefore, by placing the transparent adhesive sheet of the present invention between adjacent two layers in a front multi-layer structure comprising at least a display panel and a protective transparent plate in a flat panel display, the visibility of the images shown on the display is improved.

The transparent adhesive sheet of the present invention is produced, for example, by the following method.

A composition containing a polyoxyalkylene polymer as a main component (composition containing the above-mentioned components A-C) is charged in a stirrer equipped with a vacuum function together with an organic solvent as necessary. The mixture is defoamed by stirring under reduced pressure (in vacuo). The fluid product after said vacuum defoaming is applied (cast) to various supports, and treated with heat to form a sheet. The composition is heat-cured by a heat treatment to give a sheet of the cured product. Coating on the support can be performed using, for example, a commonly known coating apparatus such as a gravure coater; a roll coater such as a kiss coater or a comma coater; a die coater such as a slot coater or a fountain coater; a squeeze coater, a curtain coater and the like. Preferable heat treatment conditions during the coating are 50-200° C. (preferably 100-160° C.) for about 0.01-24 hr (preferably 0.05-4 hr). As the above-described stirrer with vacuum function, a commonly known stirrer equipped with vacuum apparatus may be used; specifically, a planetary (revolution type/rotation type) stirring defoaming apparatus, a defoaming apparatus equipped with a disperser, and the like can be mentioned. The degree of pressure reduction in performing vacuum defoaming is preferably not more than 10 kPa, more preferably not more than 3 kPa. Stirring time varies also depending on the choice of stirrer and the throughput of fluidized product, and is generally preferably about 0.5 to 2 hours. By the defoaming treatment, bubbles (voids) substantially do not exist in the sheet, and the sheet shows superior optical property (transparency). For example, the Haze value of a sheet measured by the below-mentioned test method is preferably not more than 1.2%, more preferably not more than 0.9%.

Particularly, when the transparent adhesive sheet of the present invention is used to adhere two adjacent layers in a front multi-layer structure part to be mounted on compact equipments such as mobile phones, mobile game machines, car navigation systems and the like, the sheet needs to be processed into a sheet with a small area size. However, for mass production (production efficiency), for example, it is preferable to produce a roll consisting of a laminate structure of a first support (base separator)/cured product layer of composition containing the above-mentioned components A to C (transparent adhesive sheet)/second support (cover separator), and produce sheets by a punching process while developing the roll.

The above-mentioned roll can be prepared by, for example, a mold release treatment by applying a mold release treatment agent to a first support, stirring and vacuum defoaming the composition containing the above-mentioned components A to C, applying (casting) the fluidized product after vacuum defoaming to a first support, heat treating the supported to give a sheet, adhering a second support after a mold release treatment to the sheet, and winding the sheet into a roll.

Specific examples of the first and second supports include films (sheets) having a single layer made of thermoplastic resin such as polyester (e.g., polybutylene terephthalate (PBT) etc.), ionomer resin wherein ethylene-methacrylic acid copolymer ate intermolecularly crosslinked with metal ion (Na⁺, Zn²⁺ etc.), EVA (ethylene-vinyl acetate copolymer), PVC (polyvinyl chloride), EEA (ethylene-ethyl acrylate copolymer), PE (polyethylene), PP (polypropylene), polyamide, polybutyral, polystyrene and the like; various thermoplastic elastomers showing rubber elasticity such as polystyrene, polyolefin, polydiene, vinyl chloride, polyurethane, polyester, polyamide, fluororesin, chlorinated polyethylene, polynorbornane, polystyrene-polyolefin copolymer, (hydrogenated) polystyrene-butadiene copolymer, polystyrene-vinylpolyisoprene copolymer and the like; polyolefin such as polyethylene, polypropylene and the like blended with a thermoplastic elastomer and the like, films (sheets) having multiple layers (laminate) made of polyolefin (polypropylene (PP) or polyethylene (PE) etc.)/thermoplastic resin (e.g., EVA)/polyolefin, polyolefin (PP or PE)+thermoplastic elastomer/polyolefin (PP or PE), PP/PE/PP and the like, composite multi-layers (laminate) of polyolefin+thermoplastic elastomer at different blending ratios, etc., and the like. In addition, impregnated paper, coated paper, quality paper, craft paper, cloth, acetate cloth, non-woven fabric, glass cloth and the like can be mentioned.

Examples of the agent for mold release treatment to be used for the first and second supports include silicone mold release treating agent, fluorine mold release treating agent, long chain alkyl mold release treating agent and the like. Of these, a silicone mold release treating agent is preferable. As the curing method, a curing method such as UV irradiation, electron beam irradiation and the like are preferably used. Furthermore, of the silicone mold release treating agents, a cationic polymerizable UV curing silicone mold release treating agent is preferable. A cationic polymerizable UV curing silicone mold release treating agent is a mixture of a cationic polymerizable silicone (polyorganosiloxane having an epoxy functional group in a molecule) and an onium salt photoinitiator. Such agent wherein the onium salt photoinitiator is a boron photoinitiator is particularly preferable. Using such a cationic polymerizable UV curing silicone mold release treating agent wherein the onium salt photoinitiator is a boron photoinitiator, particularly good release property (mold releasability) can be obtained. A cationic polymerizable silicone (polyorganosiloxane having an epoxy functional group in a molecule) has at least two epoxy functional groups in one molecule, which may be linear or branched chain, or a mixture of these. While the kind of an epoxy functional group contained in polyorganosiloxane is not particularly limited, it only needs to permit progress of cationic ring-opening polymerization by an onium salt photoinitiator. Specific examples thereof include γ-glycidyloxypropyl group, β-(3,4-epoxycyclohexyl)ethyl group, β-(4-methyl-3,4epoxycyclohexyl)propyl group and the like. Such cationic polymerizable silicone (polyorganosiloxane having an epoxy functional group in a molecule) is marketed and a commercially available product can be used. For example, UV9315, UV9430, UV9300, TPR6500, TPR6501 and the like manufactured by Toshiba Silicone Co., Ltd., X-62-7622, X-62-7629, X-62-7655, X-62-7660, X-62-7634A and the like manufactured by Shin-Etsu Chemical Co., Ltd., Poly200, Poly201, RCA200, RCA250, RCA251 and the like manufactured by Arakawa Chemical Industries, Ltd. can be mentioned.

Of the cationic polymerizable silicones, polyorganosiloxane comprising the following structural units (A) to (C) is particularly preferable.

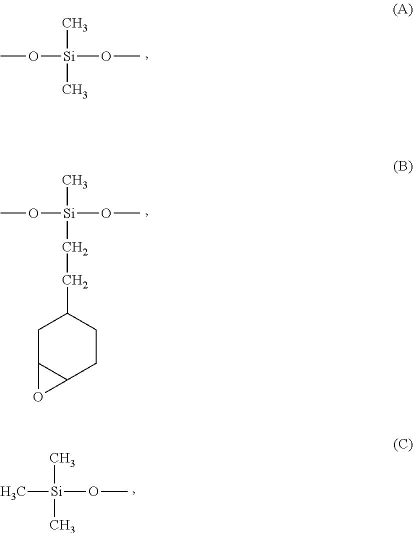

In polyorganosiloxane comprising such structural units (A) to (C), the composition ratio ((A):(B):(C)) of structural units (A) to (C) is particularly preferably 50-95:2-30:1-30 (mol %), and especially preferably 50-90:2-20:2-20 (mol %). Polyorganosiloxane comprising such structural units (A) to (C) is available as Poly200, Poly201, RCA200, X-62-7622, X-62-7629 and X-62-7660.

On the other hand, as the onium salt photoinitiator, a known product can be used without particular limitation. Specific examples include a compound represented by (R¹)₂I⁺X⁻, ArN₂⁺X⁻ or (R¹)₃S⁺X⁻ (wherein R¹ is alkyl group and/or aryl group, Ar is aryl group, X⁻ is [B(C₆H₅)₄]⁻, [B(C₆F₅)₄]^{—}, [B(C₆H₄CF₃)₄]⁻, [(C₆F₅)₂BF₂]⁻, [C₆F₅BF₃]⁻, [B(C₆H₃F₂)₄]⁻, BF₄⁻, PF₆⁻, AsF₆⁻, HSO₄⁻, ClO₄⁻ and the like). Of these, a compound of the formula (boron photoinitiator) wherein X⁻ is [B(C₆H₅)₄]⁻, [B(C₆F₅)₄]⁻, [B(C₆H₄CF₃)₄]⁻, [(C₆F₅)₂BF₂]⁻, [C₆F₅BF₃]⁻, [B(C₆H₃F₂)₄]⁻ or BF₄⁻ is preferable, and a compound represented by (R¹)₂I⁺[B(C₆F₅)₄] (wherein R¹ is substituted or unsubstituted phenyl group) (alkyl iodonium, tetrakis(pentafluorophenyl)borate) is particularly preferable. As the onium salt photoinitiator, antimony (Sb) initiator is conventionally known. However, when an antimony (Sb) initiator is used, double detachment occurs and detachment of an impact absorption sheet from a support tends to be difficult.

While the amount of the onium salt photoinitiator to be used is not particularly limited, it is about preferably 0.1 −10 parts by weight relative to 100 parts by weight of the cationic polymerizable silicone (polyorganosiloxan). When the amount of use is smaller than 0.1 part by weight, curing of the silicone peel layer may become insufficient. When the amount of use is greater than 10 parts by weight, the cost becomes impractical. When a cationic polymerizable silicone (polyorganosiloxan) and an onium salt photoinitiator are mixed, the onium salt photoinitiator may be dissolved or dispersed in an organic solvent and then mixed with polyorganosiloxan. Specific examples of the organic solvent include alcohol solvents such as isopropyl alcohol, n-butanol and the like; ketone solvents such as acetone, methylethyl ketone and the like; ester solvents such as ethyl acetate and the like, and the like.

A mold release treating agent can be applied, for example, using a general coating apparatus such as those used for roll coater method, reverse coater method, doctor blade method and the like. While the coating amount (solid content) of the mold release treating agent is not particularly limited, it is generally about 0.05-6 mg/cm².

Moreover, the transparent adhesive sheet of the present invention shows a shear storage elastic modulus (G′) of not more than 6.0×10⁵ (Pa), preferably not more than 5.5×10⁵ (Pa), at −30° C. While the shear storage elastic modulus (G′) is known as an index of the hardness of viscoelastic form, the transparent adhesive sheet of the present invention shows a shear storage elastic modulus (G′) at −30° C. of not more than 6.0×10⁵(Pa) and does not become rigid at low temperature. Therefore, the sheet is assumed to maintain a high adhesion force even at a temperature below zero. The shear storage elastic modulus at −50° C. is not more than 6.0×10⁵ (Pa). Thus, the sheet is considered to be highly superior in the adhesion stability at low temperature.

Furthermore, for example, when, in liquid crystal displays (LCD) to be mounted on portable image display equipment such as mobile game machines, digital video cameras, car navigation systems, compact music players, compact video players, cell phones and the like, what is called a touch panel mechanism permitting operation of equipment by pressing what is displayed on the liquid crystal image screen at the liquid crystal panel is to be set, the transparent adhesive sheet of the present invention is adhered to a glass or plastic film with a transparent electrode layer formed thereon. In this case, since the transparent adhesive sheet of the present invention has superior non-corrosiveness of transparent conductive materials (particularly ITO non-corrosiveness), which does not cause corrosion of transparent conductive materials such as ITO, TO (tin oxide), ZnO (zinc oxide), CTO (cadmium tin oxide) and the like, even when the sheet is contacted with the transparent conductive materials, the sheet acts advantageously when a touch panel is present between a protective transparent plate and a display module.

While the thickness of the transparent adhesive sheet of the present invention varies depending on the kind and the like of the flat panel display, it is generally not more than 1000 μm, further not more than 500 μm, to provide a thin flat panel display. A too small a thickness is not preferable for the absorption of a level difference in the printed part formed on the protective panel. Therefore, the lower limit of the thickness is preferably not less than 10 μm, more preferably 15-300 μm, and particularly preferably 25-250 μm.

The transparent adhesive sheet of the present invention can be basically prepared without a solvent, and characteristically contains smaller amounts of low molecular weight, highly volatile oligomer components and monomer components. Therefore, use of the sheet for equipments with a flat panel display, which are increasingly used every day in recent years, is advantageous, since an adverse influence on the human body is small.

### EXAMPLES

The present invention is explained in more detail in the following by referring to Examples and Comparative Examples. The present invention is not limited by the following Examples. The properties of the adhesive sheets of Examples and Comparative Examples were evaluated (tested) by the following methods.

### [Haze Value]

An adhesive sheet having an adhesive layer thickness of 175 μm was cut out to give a test sample piece having the size of 50 mm×25 mm. The sample piece was adhered to a glass substrate (S-1111 (trade name) manufactured by Matsunami GLASS Ind., LTD.) to give a measurement test sample. The haze value was measured using a haze meter (HM-150 (trade name) manufactured by MURAKAMI COLOR RESEARCH LABORATORY CO., Ltd.), where the sample was set to be on an acceptance surface side of the apparatus, a separator (support) of the test piece was peeled off and the measurement was performed according to JIS K 7136.

[180° Peel Adhesion Force (from Glass Release Force)]

A sample piece (width 25 mm, length 100 mm) was cut out from an adhesive sheet (thickness 175 μm). The separator (support) of the sample piece was peeled off, and the sample was press-adhered to a glass plate (PD200 manufactured by Asahi Glass Co., Ltd.) under the condition of adhesion by one reciprocation of 2 kg role, and left standing for 24 hr at room temperature. This was mounted on a tensile tester, peeled off at a tension rate of 300 mm/min in a 180° direction, and the peel adhesion force of the sample piece was measured.

### Example 1

A composition comprising a polyoxyalkylene polymer (Component A) (number average molecular weight: about 20,000), a hydrosilyl compound (Component B) and a hydrosilylation catalyst (Component C), wherein Component A and Component B are contained at an amount ratio such that excess hydrosilyl group in Component B (total number of moles of hydrosilyl group in Component B−total number of moles of alkenyl group in Component A) is 50% of the total number of moles of the alkenyl group in Component A, and component C is mixed in an amount of 2×10⁻⁴ mol per 1 mol of alkenyl group in Component A (manufactured by Kaneka Corporation) was cast in a stirrer with vacuum apparatus (Mini Dappo manufactured by Seatec Corporation), and defoamed by stirring in vacuo (100 Pa) for 1 hr. Then, the vacuum defoamed composition was applied (cast) onto a base separator (support) made of a polyester film (thickness: 100 μm) subjected to a mold release treatment, using a roll coater at room temperature to a composition thickness of 175 μm. The composition was cured by heating in a heating oven at 130° C. for 10 min. A cover separator (release liner) made of a polyester film (thickness: 100 μm) subjected to a mold release treatment in the same manner was adhered to the thus-obtained cured sheet to give a transparent adhesive sheet (measured thickness: 175 μm). The obtained transparent adhesive sheet had high transparency (haze value: 0.3%), and showed no mixing of bubbles. The 180° peel adhesion force (release force from glass) of the transparent adhesive sheet was evaluated.

### Example 2

In the same manner as in Example 1 except that the amount of the hydrosilyl compound (Component B) in the composition comprising components A-C was changed such that the total number of moles of excess hydrosilyl group in Component B (total number of moles of hydrosilyl group in Component B−total number of moles of alkenyl group in Component A) was 100% relative to the total number of moles of Component A to the alkenyl group, a transparent adhesive sheet was prepared.

The Haze value of the obtained transparent adhesive sheet was 0.3%. The 180° peel adhesion force (release force from glass) of the transparent adhesive sheet was evaluated.

### Example 3

In the same manner as in Example 1 except that the amount of the hydrosilyl compound (Component B) in the composition comprising components A-C was changed such that the total number of moles of excess hydrosilyl group in Component B (total number of moles of hydrosilyl group in Component B−total number of moles of alkenyl group in Component A) was 150% relative to the total number of moles of Component A to the alkenyl group, a transparent adhesive sheet was prepared.

The Haze value of the obtained transparent adhesive sheet was 0.3%. The 180° peel adhesion force (release force from glass) of the transparent adhesive sheet was evaluated.

### Comparative Example 1

In the same manner as in Example 1 except that the amounts of the hydrosilyl compound (Component B) and the polyoxyalkylene polymer (Component A) in the composition comprising components A-C were changed such that the total number of moles of the hydrosilyl group of Component B and that of the alkenyl group of Component A are the same, a transparent adhesive sheet was prepared.

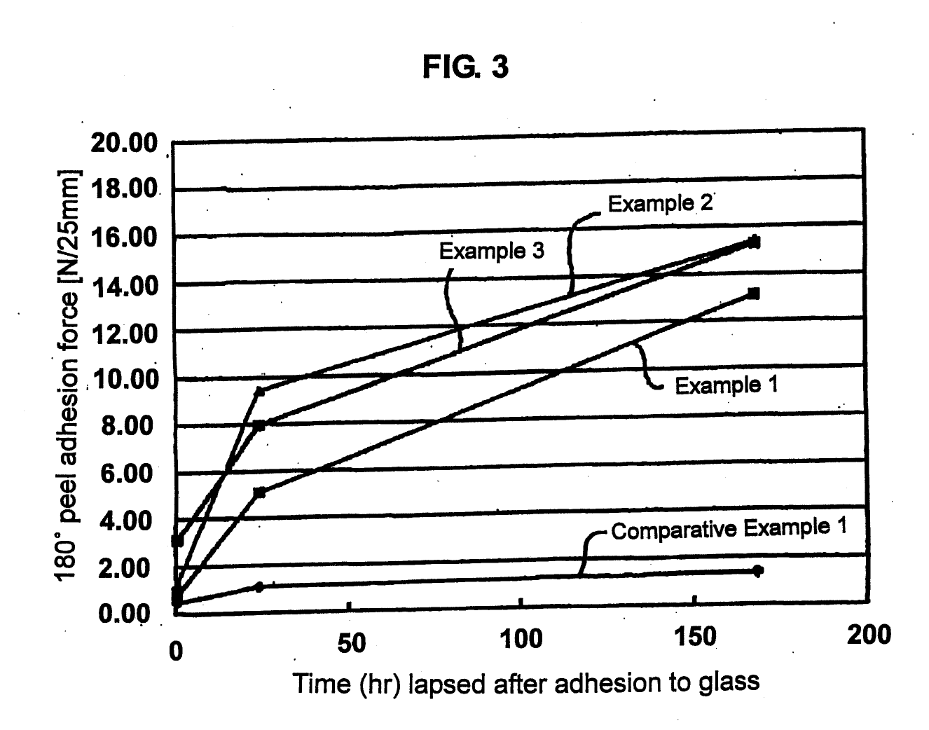

FIG. 3 shows time course changes of 180° peel adhesion force (release force from glass) of the adhesive sheets of Examples 1-3 and Comparative Example 1.

From FIG. 3, the adhesive sheets of Examples 1-3 showed a rapid increase in the adhesion force (release force) in 24 hr from the adhesion to a glass plate, and the adhesion force (release force) still increased thereafter. In Example 1 wherein an increase in the adhesion force (release force) within 24 hr from adhesion was the smallest, the adhesion force (release force) reached 10N/25 mm in 150 hr from the adhesion. In contrast, the adhesive sheet of Comparative Example 1 showed an adhesion force (release force) smaller than not less than 2N/25 mm even after lapse of not less than 150 hr, and expected to require not less than 1000 hr to reach an adhesion force (release force) of 10N/25 mm.

### INDUSTRIAL APPLICABILITY

The present invention contributes to a protection effect and improved visibility by a protective transparent plate of a flat-panel display. In addition, the present invention can be applied to compact flat-panel displays and flat-panel displays with a touch panel, and advantageously acts for the protective effect and improved visibility by a protective transparent plate in compact flat-panel displays and flat-panel displays with a touch panel.

This application is based on a patent application No. 2008-268878 filed in Japan, the contents of which are incorporated in full herein.

### EXPLANATION OF SYMBOLS

1 transparent adhesive sheet
2 liquid crystal display, panel
3 protective transparent plate
4 touch panel
100, 200 flat panel displays

1. A transparent adhesive sheet for a flat panel display comprised of a cured product of a composition comprising the following components A-C, wherein the total number of moles of the hydrosilyl group in Component B is higher than the total number of moles of the alkenyl group in Component A, and Component A and Component B are contained at an amount ratio such that the number of moles of excess hydrosilyl group in Component B (total number of moles of hydrosilyl group in Component B−total number of moles of alkenyl group in Component A) is not less than 50% of the total number of moles of the alkenyl group in Component A:
A: a polyoxyalkylene based polymer having at least one alkenyl group in one molecule
B: a compound having an average of not less than 2 hydrosilyl groups in one molecule, and
C: a hydrosilylation catalyst.

2. The transparent adhesive sheet of claim 1, wherein the number of moles of excess hydrosilyl group in Component B (total number of moles of hydrosilyl group in Component B−total number of moles of alkenyl group in Component A) is not less than 80% of the total number of moles of the alkenyl group in Component A.

3. The transparent adhesive sheet of claim 1, wherein the number of moles of excess hydrosilyl group in Component B (total number of moles of hydrosilyl group in Component B−total number of moles of alkenyl group in Component A) is not less than 100% of the total number of moles of the alkenyl group in Component A.

4. The transparent adhesive sheet of claim 1, which is used for adhesion of adjacent two layers in a multi-layer structure on the display surface side in a flat panel display, which structure comprising a display panel and a protective transparent plate, or a display panel and the protective transparent plate and further at least one other functional layer between them.

5. The transparent adhesive sheet of claim 4, wherein at least one of the adjacent two layers is a glass plate.

6. A flat panel display comprising a protective transparent plate comprised of a glass plate and a display panel, which are integrated by adhesion via the transparent adhesive sheet of claim 1 disposed between the protective transparent plate and the display panel.

7. A flat panel display comprising a protective transparent plate comprised of a glass plate, a display panel and a touch panel inserted between the protective transparent plate and the display panel, wherein the transparent adhesive sheet of claim 1 is disposed between a glass plate on the outermost layer of the touch panel and the protective transparent plate, and between a glass plate on the outermost layer of the other side of the touch panel and the display panel, whereby the protective transparent plate, the display panel and the touch panel are integrated by adhesion.

8. The transparent adhesive sheet of claim 2, which is used for adhesion of adjacent two layers in a multi-layer structure on the display surface side in a flat panel display, which structure comprising a display panel and a protective transparent plate, or a display panel and the protective transparent plate and further at least one other functional layer between them.

9. The transparent adhesive sheet of claim 8, wherein at least one of the adjacent two layers is a glass plate.

10. The transparent adhesive sheet of claim 3, which is used for adhesion of adjacent two layers in a multi-layer structure on the display surface side in a flat panel display, which structure comprising a display panel and a protective transparent plate, or a display panel and the protective transparent plate and further at least one other functional layer between them.

11. The transparent adhesive sheet of claim 10, wherein at least one of the adjacent two layers is a glass plate.

12. A flat panel display comprising a protective transparent plate comprised of a glass plate and a display panel, which are integrated by adhesion via the transparent adhesive sheet of claim 2 disposed between the protective transparent plate and the display panel.

13. A flat panel display comprising a protective transparent plate comprised of a glass plate and a display panel, which are integrated by adhesion via the transparent adhesive sheet of claim 3 disposed between the protective transparent plate and the display panel.

14. A flat panel display comprising a protective transparent plate comprised of a glass plate, a display panel and a touch panel inserted between the protective transparent plate and the display panel, wherein the transparent adhesive sheet of claim 2 is disposed between a glass plate on the outermost layer of the touch panel and the protective transparent plate, and between a glass plate on the outermost layer of the other side of the touch panel and the display panel, whereby the protective transparent plate, the display panel and the touch panel are integrated by adhesion.

15. A flat panel display comprising a protective transparent plate comprised of a glass plate, a display panel and a touch panel inserted between the protective transparent plate and the display panel, wherein the transparent adhesive sheet of claim 3 is disposed between a glass plate on the outermost layer of the touch panel and the protective transparent plate, and between a glass plate on the outermost layer of the other side of the touch panel and the display panel, whereby the protective transparent plate, the display panel and the touch panel are integrated by adhesion.
